(19) United States
(12) Patent Application Publication
(10) Pub. No.: US 2026/0278514 A1
(43) Pub. Date: Sep. 17, 2026

(54) System for Evaluating Employee Capabilities

(71) Applicant: SoftBank Group Corp., Tokyo (JP)

(72) Inventor: Hiroki NAKATANI, Tokyo (JP)

(21) Appl. No.: 19/564,212

(22) Filed: Mar. 12, 2026

Related U.S. Application Data
(60) Provisional application No. 63/771,648, filed on Mar. 14, 2025.

(51) Int. Cl. G06Q 10/0639; G06F 40/253

(52) U.S. Cl. CPC G06Q 10/06398; G06F 40/253

(57) ABSTRACT

Client software installed on an employee's terminal collects emails and documents in real time and sends them to a server. On the server side, data is analyzed using natural language processing technology to extract parts of speech such as nouns and verbs, and identify frequently appearing technical terms. Furthermore, email metadata is utilized to perform weighting of terms and evaluate the employee's influence. A comparison unit compares the extracted terms with those of other employees to identify employees with specific skills. Finally, a generation unit automatically generates an introductory text for the employee using GPT.

### CROSS-REFERENCE TO RELATED APPLICATION

This application claims the benefit of priority from U.S. Provisional Patent Application No. 63/771,648, filed on Mar. 14, 2025. The entire contents of the priority application are incorporated herein by reference.

### BACKGROUND

The technology of the present disclosure relates to a system.

Japanese Unexamined Patent Publication No. 2022-180282 discloses a method, which is a persona chatbot control method performed by at least one processor, the method including a step of receiving a user utterance, a step of adding the user utterance to a prompt including an instruction sentence associated with a description regarding a character of a chatbot, a step of encoding the prompt, and a step of inputting the encoded prompt to a language model to generate a chatbot utterance responding to the user utterance.

### SUMMARY

A problem to be solved by this disclosure is to accurately and efficiently grasp the capabilities and skills of employees. Conventionally, in order to evaluate the capabilities of employees, it was necessary for the employees themselves to manually update their own skills and achievements, and for managers to conduct evaluations based on that. However, since this method relies on the self-reporting of employees, it may lack accuracy and comprehensiveness of information, and the effort of updating information becomes a significant burden for the employees.

Furthermore, existing systems for grasping employee capabilities are premised on employees inputting information themselves, so there is a risk that employees may underestimate or, conversely, overestimate their own skills. This makes it difficult for managers to accurately evaluate the actual capabilities of employees, and there is a possibility that appropriate personnel placement and development will not be carried out.

In order to solve these problems, the present disclosure provides a system that automatically extracts skills from employee emails and documents and generates an introductory text for the employee. This system makes it possible to evaluate employee capabilities based on objective data, without relying on employee self-reporting. In addition, it eliminates the effort for employees to manually update information, and enables managers to quickly and accurately grasp employee capabilities. This improves the efficiency of human resource management for the entire organization and promotes appropriate personnel placement and development.

As a means for solving the problem, the present disclosure provides a system for grasping the capabilities of employees. This system includes an input unit that receives employee emails and documents as input data, and thereby can automatically collect documents that employees create on a daily basis. Next, the system includes an analysis unit that analyzes the input data to extract terms and phrases used by the employee. This analysis unit uses natural language processing technology to identify meaningful words and phrases from text and extract information indicating the employee's skills and expertise.

Furthermore, the system includes a weighting unit that performs weighting on the extracted terms and phrases based on the destination and number of recipients of an email. This weighting unit adjusts the importance of terms according to the number and job titles of email recipients, and provides an index for evaluating the employee's influence and range of communication.

The system also includes a comparison unit that compares the extracted terms and phrases with those of other employees throughout the company or within a department. This comparison unit measures how characteristic a specific term is, and clarifies what kind of skills and expertise an employee has compared to other employees.

Finally, the system includes a generation unit that automatically generates an introductory text for the employee based on the result of the comparison. This generation unit incorporates the extracted skills and characteristic terms to generate an introductory text that accurately expresses the employee's capabilities, and provides information for managers to quickly and accurately grasp the employee's capabilities. In this way, it becomes possible to evaluate employee capabilities based on objective data, without relying on employee self-reporting.

### BRIEF DESCRIPTION OF DRAWINGS

FIG. 1 is a conceptual diagram illustrating an example of a configuration of a data processing system according to a first embodiment.

FIG. 2 is a conceptual diagram illustrating an example of main functions of a data processing apparatus and a smart device according to the first embodiment.

FIG. 3 is a conceptual diagram illustrating an example of a configuration of a data processing system according to a second embodiment.

FIG. 4 is a conceptual diagram illustrating an example of main functions of a data processing apparatus and smart glasses according to the second embodiment.

FIG. 5 is a conceptual diagram illustrating an example of a configuration of a data processing system according to a third embodiment.

FIG. 6 is a conceptual diagram illustrating an example of main functions of a data processing apparatus and a headset-type terminal according to the third embodiment.

FIG. 7 is a conceptual diagram illustrating an example of a configuration of a data processing system according to a fourth embodiment.

FIG. 8 is a conceptual diagram illustrating an example of main functions of a data processing apparatus and a robot according to the fourth embodiment.

FIG. 9 illustrates an emotion map on which a plurality of emotions are mapped.

FIG. 10 illustrates an emotion map on which a plurality of emotions are mapped.

FIG. 11 is a flowchart illustrating an example of a method for evaluating employee capabilities.

### DETAILED DESCRIPTION

Hereinafter, an example of an embodiment of a system according to the technology of the present disclosure will be described with reference to the accompanying drawings.

First, terms used in the following description will be described.

In the following embodiments, a processor with a reference sign (hereinafter, simply referred to as a “processor”) may be one arithmetic device or may be a combination of a plurality of arithmetic devices. Also, the processor may be one type of arithmetic device or may be a combination of a plurality of types of arithmetic devices. Examples of the arithmetic device include a CPU (Central Processing Unit), a GPU (Graphics Processing Unit), a GPGPU (General-Purpose computing on Graphics Processing Units), an APU (Accelerated Processing Unit), and the like.

In the following embodiments, a RAM (Random Access Memory) with a reference sign is a memory in which information is temporarily stored, and is used as a work memory by a processor.

In the following embodiments, a storage with a reference sign is one or more non-volatile storage devices that store various programs, various parameters, and the like. Examples of the non-volatile storage device include a flash memory (SSD (Solid State Drive)), a magnetic disk (for example, a hard disk), or a magnetic tape, and the like.

In the following embodiments, a communication I/F (Interface) with a reference sign is an interface including a communication processor, an antenna, and the like. The communication I/F manages communication among a plurality of computers. An example of a communication standard applied to the communication I/F includes a wireless communication standard including 5G (5th Generation Mobile Communication System), Wi-Fi (registered trademark), or Bluetooth (registered trademark), and the like.

In the following embodiments, “A and/or B” is synonymous with “at least one of A and B”. That is, “A and/or B” means that it may be A only, B only, or a combination of A and B. Also, in the present specification, when three or more matters are expressed by being connected with “and/or”, the same concept as “A and/or B” is applied.

### First Embodiment

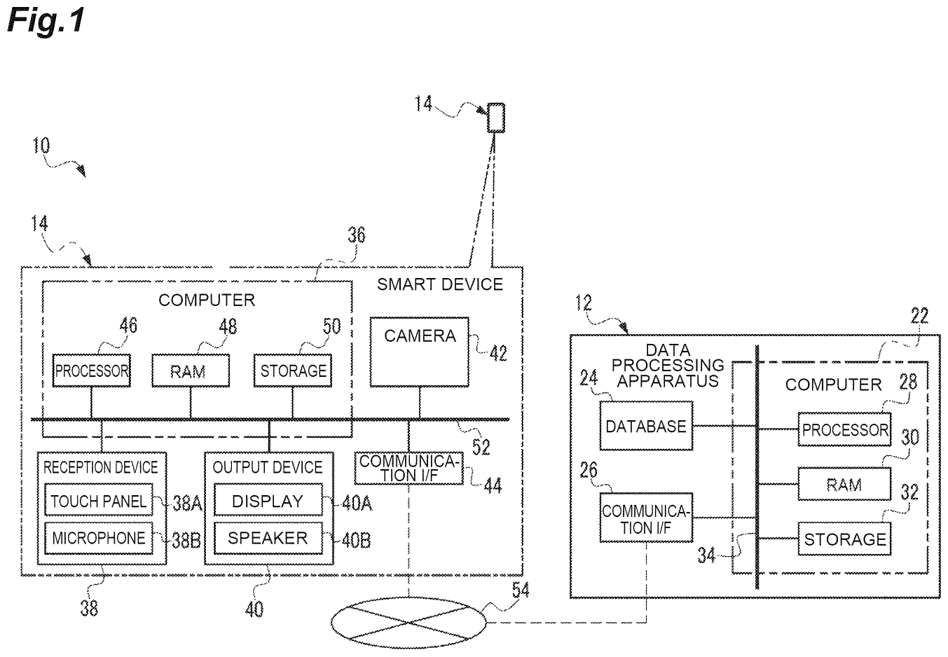

FIG. 1 illustrates an example of a configuration of a data processing system 10 according to a first embodiment.

As illustrated in FIG. 1, the data processing system 10 includes a data processing apparatus 12 and a smart device 14. An example of the data processing apparatus 12 includes a server.

The data processing apparatus 12 includes a computer 22, a database 24, and a communication I/F 26. The computer 22 is an example of a “computer” according to the technology of the present disclosure. The computer 22 includes a processor 28, a RAM 30, and a storage 32. The processor 28, the RAM 30, and the storage 32 are connected to a bus 34. Also, the database 24 and the communication I/F 26 are also connected to the bus 34. The communication I/F 26 is connected to a network 54. An example of the network 54 includes a WAN (Wide Area Network) and/or a LAN (Local Area Network), and the like.

The smart device 14 includes a computer 36, a reception device 38, an output device 40, a camera 42, and a communication I/F 44. The computer 36 includes a processor 46, a RAM 48, and a storage 50. The processor 46, the RAM 48, and the storage 50 are connected to a bus 52. Also, the reception device 38, the output device 40, and the camera 42 are also connected to the bus 52.

The reception device 38 includes a touch panel 38A, a microphone 38B, and the like, and receives a user input. The touch panel 38A receives a user input by contact of an indicator by detecting contact of the indicator (for example, a pen or a finger, etc.). The microphone 38B receives a user input by voice by detecting a user's voice. A control unit 46A transmits data indicating the user input received by the touch panel 38A and the microphone 38B to the data processing apparatus 12. In the data processing apparatus 12, a specific processing unit 290 acquires the data indicating the user input.

The output device 40 includes a display 40A, a speaker 40B, and the like, and presents data to a user 20 by outputting the data in a representation form (for example, voice and/or text) perceivable by the user 20. The display 40A displays visible information such as text and images in accordance with an instruction from the processor 46. The speaker 40B outputs voice in accordance with an instruction from the processor 46. The camera 42 is a small digital camera on which an optical system such as a lens, a diaphragm, and a shutter, and an image sensor such as a CMOS (Complementary Metal-Oxide-Semiconductor) image sensor or a CCD (Charge Coupled Device) image sensor are mounted.

The communication I/F 44 is connected to the network 54. The communication I/Fs 44 and 26 manage exchange of various information between the processor 46 and the processor 28 via the network 54.

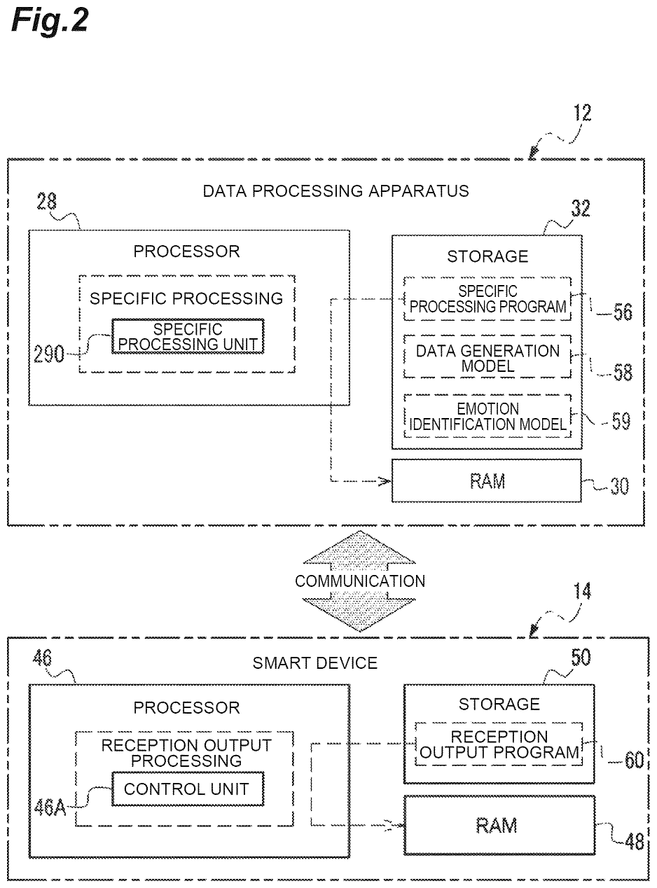

FIG. 2 illustrates an example of main functions of the data processing apparatus 12 and the smart device 14.

As illustrated in FIG. 2, in the data processing apparatus 12, specific processing is performed by the processor 28. A specific processing program 56 is stored in the storage 32. The specific processing program 56 is an example of a “program” according to the technology of the present disclosure. The processor 28 reads the specific processing program 56 from the storage 32 and executes the read specific processing program 56 on the RAM 30. The specific processing is realized by the processor 28 operating as a specific processing unit 290 in accordance with the specific processing program 56 executed on the RAM 30.

A data generation model 58 and an emotion identification model 59 are stored in the storage 32. The data generation model 58 and the emotion identification model 59 are used by the specific processing unit 290. The specific processing unit 290 can estimate a user's emotion using the emotion identification model 59 and perform specific processing using the user's emotion. In an emotion estimation function (emotion identification function) using the emotion identification model 59, various estimations and predictions regarding the user's emotion, including estimation and prediction of the user's emotion, are performed, but the present disclosure is not limited to such an example. Also, the estimation and prediction of emotion include, for example, analysis (analytics) of emotion and the like.

In the smart device 14, reception output processing is performed by the processor 46. A reception output program 60 is stored in the storage 50. The reception output program 60 is used in combination with the specific processing program 56 by the data processing system 10. The processor 46 reads the reception output program 60 from the storage 50 and executes the read reception output program 60 on the RAM 48. The specific processing is realized by the processor 46 operating as a control unit 46A in accordance with the specific processing program 60 executed on the RAM 48. Note that the smart device 14 can also have a data generation model and an emotion identification model similar to the data generation model 58 and the emotion identification model 59, and perform processing similar to that of the specific processing unit 290 using these models. The reception output processing is realized by the processor 46 operating as the control unit 46A in accordance with the reception output program 60 executed on the RAM 48.

Note that an apparatus other than the data processing apparatus 12 may have the data generation model 58. For example, a server apparatus (for example, a generation server) may have the data generation model 58. In this case, the data processing apparatus 12 obtains a processing result (such as a prediction result) in which the data generation model 58 is used, by communicating with the server apparatus having the data generation model 58. Also, the data processing apparatus 12 may be a server apparatus, or may be a terminal device owned by a user (for example, a mobile phone, a robot, a home appliance, etc.). Next, an example of processing by the data processing system 10 according to the first embodiment will be described.

### Example 1

A flow of specific processing in Example 1 will be described. Each unit of the system described below is realized by the data processing apparatus 12 and the smart device 14. Also, the data processing apparatus 12 is referred to as a “server”, and the smart device 14 is referred to as a “terminal”.

### Embodiment

An embodiment will be described more specifically and in detail.

First, an input unit configured to collect employee emails and documents is realized by dedicated client software installed on an employee's terminal. The input unit may be configured by, for example, the reception device 38 and the communication I/F 44. This client software has a function of linking with an email client or document creation software and monitoring emails sent and received by the employee or documents created by the employee in real time. For example, it includes a function of automatically transferring the content of an email to a server for analysis when the email is sent, and a function of extracting the content of a document and uploading it to the server when the document is saved. It also includes a function of periodically scanning files saved by an employee in a specific folder, detecting newly added documents, and sending them to the server.

The input unit may be configured to adopt a distributed computing architecture. Specifically, on the employee's terminal (edge device) side, preprocessing including masking of personal identifiable information (PII) and tokenization of text is performed on the collected email and document data. This preprocessing reduces the amount of data transmitted to the server, suppresses consumption of network bandwidth, and reduces the computational load on the server side. In addition, this preprocessing is executed as a background process using the idle time of the terminal, and is scheduled so as to prevent performance degradation of the terminal during the employee's normal work.

Next, on the server side, an analysis unit configured to analyze the received data is provided. The analysis unit may be configured by, for example, the specific processing unit 290, the specific processing program 56, the data generation model 58, and the emotion identification model 59. This analysis unit is configured to use advanced natural language processing technology to extract parts of speech such as nouns, verbs, and adjectives from emails and documents, and calculate the appearance frequency of each word. Specifically, it performs morphological analysis, classifies words in a document for each part of speech, and identifies frequently appearing technical terms and jargon. For example, if terms related to a specific programming language or technology framework appear frequently, it can be used as an indicator that the employee is proficient in that technology. It is also possible to extract proper nouns such as project names and customer names to identify projects and business partners in which the employee was involved.

The analysis unit is configured to execute vectorization processing (for example, using Word2Vec, BERT, or a Transformer-based model) for mapping the extracted words and phrases to a high-dimensional vector space. The analysis unit calculates cosine similarity between a vector generated from the employee's document and a vector related to a known skill set definition. This enables identification of skills based not only on exact match of keywords but also on semantic context. This processing includes matrix operations of a scale that cannot be calculated by human mental activity, and is preferably processed in parallel using a dedicated hardware accelerator (GPU or TPU).

Furthermore, the server is provided with a weighting unit configured to perform weighting on the extracted terms and phrases. The weighting unit may be configured by, for example, the specific processing unit 290, the specific processing program 56, the data generation model 58, and the emotion identification model 59. This weighting unit is configured to utilize email metadata to adjust the importance of terms, taking into account the number of recipients, the job titles of the recipients, and the presence or absence of CC and BCC in the email. For example, if an email is sent to many recipients, the terms in that email are judged to have a high possibility of affecting the entire organization, and the weight is increased. In addition, the weight of terms in emails sent to important job titles such as executives and department heads is also increased. This makes it possible to evaluate what kind of influence an employee has within the organization.

The weighting unit is configured to construct a graph structure (Social Graph) with employees as nodes and communication as edges based on communication logs within the organization, and dynamically calculate an influence score of each employee using a PageRank algorithm or Eigenvector Centrality. The weight $W$ of a term is determined based on a specific calculation formula such as, for example, $W=tf ¥times idf ¥times (1+¥alpha ¥cdot S_) $ (where $¥alpha$ is an adjustment coefficient), using the appearance frequency $tf$ of the term, the inverse document frequency $idf$, and the influence score $S_$ of the recipient. This quantifies the importance of dynamic information in the actual workflow, not just static job title information.

The server is further provided with a comparison unit configured to compare the extracted terms and phrases with those of other employees throughout the company or within a department. The comparison unit may be configured by, for example, the specific processing unit 290, the specific processing program 56, the data generation model 58, and the emotion identification model 59. This comparison unit is configured to use TF-IDF (Term Frequency-Inverse Document Frequency) to measure how characteristic a specific term is. Specifically, it calculates the appearance frequency of terms for each employee and compares it with the database of all employees to identify which terms a specific employee uses more frequently than other employees. For example, if a specific technical term is rarely seen by other employees but is frequently used by a specific employee, a high score is given as an indicator of that employee's expertise.

Finally, the server is provided with a generation unit configured to automatically generate an introductory text for the employee based on the result of the comparison. The generation unit may be configured by, for example, the specific processing unit 290, the specific processing program 56, the data generation model 58, and the emotion identification model 59. This generation unit is configured to use GPT or Gemini to generate a natural sentence that incorporates the extracted skills and characteristic terms. Specifically, it generates an introductory text that reflects the employee's skill set and project experience, and accurately expresses the employee's capabilities. For example, if an employee has demonstrated leadership in a specific project, an introductory text that emphasizes the employee's leadership ability can be generated using terms related to that project. In addition, if an employee is proficient in a specific technology, an introductory text that emphasizes the employee's expertise can be generated using terms related to that technology.

The generation unit is configured to adopt a Retrieval-Augmented Generation (RAG) architecture. Specifically, using the characteristic skills and terms identified by the comparison unit as a query, related context information is retrieved from an in-house project database or technical document repository (Vector Database). The generation unit embeds this retrieved context information and the extracted skill information into a prompt and inputs it to a Large Language Model (LLM). This suppresses hallucinations of the LLM and generates an accurate and specific introductory text based on facts.

In this way, by the server and the terminal operating in cooperation, it becomes possible to grasp employee capabilities objectively and efficiently. This provides a foundation for managers to quickly and accurately evaluate employee capabilities and carry out appropriate personnel placement and development, without relying on employee self-reporting.

This system processes terabyte-class unstructured text data generated daily by thousands of employees in real time and dynamically updates a skill ontology. Such processing is practically impossible for a human to perform mentally in terms of data volume and processing speed. In addition, this system enables early detection of “Hidden Skills” and “adaptation to emerging technologies,” which could not be detected by conventional manual input, as anomalies in the data distribution of the entire organization.

### (System Configuration)

The system according to the present embodiment includes an input unit, an analysis unit, a weighting unit, a comparison unit, and a generation unit. The input unit is realized by dedicated client software installed on an employee's terminal, and links with an email client or document creation software that the employee uses on a daily basis. This input unit has a function of monitoring emails sent and received by the employee or documents created by the employee in real time, and sending necessary data to a server. For example, it includes a function of automatically transferring the content of an email to the server for analysis when the email is sent, a function of extracting the content of a document and uploading it to the server when the document is saved, a function of periodically scanning files saved by an employee in a specific folder, detecting newly added documents, and sending them to the server, and furthermore, a function of collecting log data of specific applications used by the employee and providing data for grasping the workflow.

The analysis unit is provided on the server side and analyzes the received data using advanced natural language processing technology. The analysis unit extracts parts of speech such as nouns, verbs, and adjectives from emails and documents, and calculates the appearance frequency of each word. Specifically, it performs morphological analysis, classifies words in a document for each part of speech, and identifies frequently appearing technical terms and jargon. For example, if terms related to a specific programming language or technology framework appear frequently, it can be used as an indicator that the employee is proficient in that technology. It is also possible to extract proper nouns such as project names and customer names to identify projects and business partners in which the employee was involved. Furthermore, the analysis unit understands the context within a document and provides information for grasping the employee's work content and role. For example, it analyzes contexts such as “fulfilled the role of a project manager” or “contributed to the development of a new product,” and generates data for evaluating the employee's role and degree of contribution.

The weighting unit is provided in the server and performs weighting on the extracted terms and phrases. This weighting unit utilizes email metadata to adjust the importance of terms, taking into account the number of recipients, the job titles of the recipients, and the presence or absence of CC and BCC in the email. For example, if an email is sent to many recipients, the terms in that email are judged to have a high possibility of affecting the entire organization, and the weight is increased. In addition, the weight of terms in emails sent to important job titles such as executives and department heads is also increased. Furthermore, the weighting unit considers the frequency of sending emails and the speed of replies, and provides an index for evaluating the employee's communication ability and influence. For example, an employee who frequently sends emails and replies promptly is evaluated as having high communication ability. In addition, if many emails related to a specific project are sent, it can be used as an indicator of the employee's degree of involvement in that project.

The comparison unit is provided in the server and compares the extracted terms and phrases with those of other employees throughout the company or within a department. This comparison unit uses TF-IDF (Term Frequency-Inverse Document Frequency) to measure how characteristic a specific term is. Specifically, it calculates the appearance frequency of terms for each employee and compares it with the database of all employees to identify which terms a specific employee uses more frequently than other employees. For example, if a specific technical term is rarely seen by other employees but is frequently used by a specific employee, a high score is given as an indicator of that employee's expertise. In addition, the comparison unit compares the employee's work content and role with those of other employees, and provides data for evaluating the employee's superiority in a specific skill or role. For example, if there are more employees who have “fulfilled the role of a project manager” than other employees, the leadership ability of that employee can be emphasized.

The generation unit is provided in the server and automatically generates an introductory text for the employee based on the result of the comparison. This generation unit uses GPT to generate a natural sentence that incorporates the extracted skills and characteristic terms. Specifically, it generates an introductory text that reflects the employee's skill set and project experience, and accurately expresses the employee's capabilities. For example, if an employee has demonstrated leadership in a specific project, an introductory text that emphasizes the employee's leadership ability can be generated using terms related to that project. In addition, if an employee is proficient in a specific technology, an introductory text that emphasizes the employee's expertise can be generated using terms related to that technology. Furthermore, the generation unit generates a prompt sentence that reflects the employee's work content and role, and has a generative AI read it, thereby generating a more accurate introductory text. For example, by using a prompt sentence such as “This employee has fulfilled the role of a project manager and contributed to the development of a new product. Please emphasize his leadership ability and technical expertise,” the generative AI can generate an introductory text that accurately expresses the employee's capabilities. In this way, by the server and the terminal operating in cooperation, it becomes possible to grasp employee capabilities objectively and efficiently. This provides a foundation for managers to quickly and accurately evaluate employee capabilities and carry out appropriate personnel placement and development, without relying on employee self-reporting.

### IMPLEMENTATION STEPS

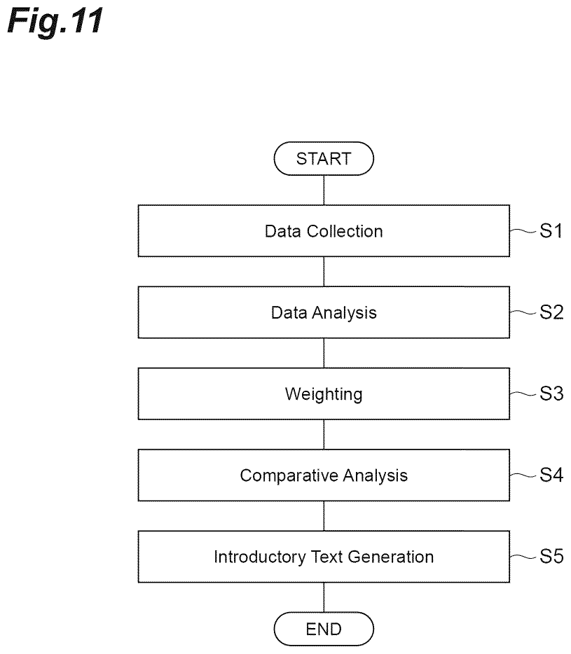

### Step 1: Data Collection (see Step S1 in FIG. 11)

The first step is to collect employee email and document data. Dedicated client software installed on an employee's terminal links with an email client or document creation software and monitors emails sent and received by the employee or documents created by the employee in real time. This software automatically transfers the content of an email to a server for analysis when the email is sent, and extracts the content of a document and uploads it to the server when the document is saved. It also includes a function of periodically scanning files saved in a specific folder, detecting newly added documents, and sending them to the server. This ensures that data related to the employee's work is collected without omission.

### Step 2: Data Analysis (see Step S2 in FIG. 11)

The next step is to analyze the collected data. An analysis unit provided on the server side uses advanced natural language processing technology to extract parts of speech such as nouns, verbs, and adjectives from emails and documents, and calculates the appearance frequency of each word. It performs morphological analysis, classifies words in a document for each part of speech, and identifies frequently appearing technical terms and jargon. For example, if terms related to a specific programming language or technology framework appear frequently, it is used as an indicator that the employee is proficient in that technology. It is also possible to extract proper nouns such as project names and customer names to identify projects and business partners in which the employee was involved.

### Step 3: Weighting (see Step S3 in FIG. 11)

This is the step of performing weighting on the analyzed terms and phrases. A weighting unit provided in the server utilizes email metadata to adjust the importance of terms, taking into account the number of recipients, the job titles of the recipients, and the presence or absence of CC and BCC in the email. For example, if an email is sent to many recipients, the terms in that email are judged to have a high possibility of affecting the entire organization, and the weight is increased. In addition, the weight of terms in emails sent to important job titles such as executives and department heads is also increased. Furthermore, it considers the frequency of sending emails and the speed of replies, and provides an index for evaluating the employee's communication ability and influence.

### Step 4: Comparative Analysis (see Step S4 in FIG. 11)

This is the step of comparing the extracted terms and phrases with those of other employees throughout the company or within a department. A comparison unit provided in the server uses TF-IDF (Term Frequency-Inverse Document Frequency) to measure how characteristic a specific term is. It calculates the appearance frequency of terms for each employee and compares it with the database of all employees to identify which terms a specific employee uses more frequently than other employees. For example, if a specific technical term is rarely seen by other employees but is frequently used by a specific employee, a high score is given as an indicator of that employee's expertise.

Step 5: Introductory Text Generation (see Step S5 in FIG. 11) The final step is to automatically generate an introductory text for the employee based on the result of the comparison. A generation unit provided in the server uses GPT to generate a natural sentence that incorporates the extracted skills and characteristic terms. In this step, a prompt sentence to be read into a generative AI is prepared. For example, by using a prompt sentence such as “This employee has fulfilled the role of a project manager and contributed to the development of a new product. Please emphasize his leadership ability and technical expertise,” the generative AI can generate an introductory text that accurately expresses the employee's capabilities. This makes it possible to generate an introductory text that reflects the employee's skill set and project experience, and to accurately express the employee's capabilities.

### (Specific Use Case)

For example, consider a case where the system of the present disclosure is introduced in a certain company to objectively evaluate employee capabilities and perform appropriate personnel placement. In this company, a lot of information regarding work is exchanged through emails and documents that employees use on a daily basis. The system uses client software installed on the employees' terminals to collect these emails and documents in real time. The collected data is sent to a server and analyzed by an analysis unit using natural language processing technology.

The analysis unit extracts parts of speech such as nouns, verbs, and adjectives from emails and documents, and identifies frequently appearing technical terms and jargon. For example, if terms related to a specific programming language or technology framework appear frequently, it is used as an indicator that the employee is proficient in that technology. It is also possible to extract proper nouns such as project names and customer names to identify projects and business partners in which the employee was involved.

The weighting unit utilizes email metadata to adjust the importance of terms, taking into account the number of recipients, the job titles of the recipients, and the presence or absence of CC and BCC in the email. For example, if an email is sent to many recipients, the terms in that email are judged to have a high possibility of affecting the entire organization, and the weight is increased. In addition, the weight of terms in emails sent to important job titles such as executives and department heads is also increased.

The comparison unit compares the extracted terms and phrases with those of other employees throughout the company or within a department. It uses TF-IDF (Term Frequency-Inverse Document Frequency) to measure how characteristic a specific term is. It calculates the appearance frequency of terms for each employee and compares it with the database of all employees to identify which terms a specific employee uses more frequently than other employees.

The generation unit automatically generates an introductory text for the employee based on the result of the comparison. As a specific example of a prompt sentence to be read into a generative AI, by using a prompt sentence such as “This employee has fulfilled the role of a project manager and contributed to the development of a new product. Please emphasize his leadership ability and technical expertise,” the generative AI can generate an introductory text that accurately expresses the employee's capabilities.

In this way, the system of the present disclosure objectively and efficiently grasps employee capabilities, and provides a foundation for managers to quickly and accurately evaluate employee capabilities and carry out appropriate personnel placement and development. This is expected to contribute to improving the efficiency of the entire company and strengthening its competitiveness.

### Application Example 1

A flow of specific processing in Application Example 1 will be described. Each unit of the system described below is realized by the data processing apparatus 12 and the smart device 14. Also, the data processing apparatus 12 is referred to as a “server”, and the smart device 14 is referred to as a “terminal”.

### Embodiment

An embodiment will be described more specifically and in detail. This embodiment is a system for grasping the capabilities of workers in a distribution center in real time and performing efficient task assignment.

First, the input unit will be described. The input unit collects various data in real time through wearable devices and mobile terminals worn by workers. Specifically, it is possible to acquire the position information of a worker using GPS or beacon technology and track the worker's movement route in detail. This makes it possible to grasp how the worker is moving within the warehouse and analyze efficient flow lines. In addition, it accurately records work time and grasps how much time is spent on each task. Furthermore, it collects operation logs of the equipment used and, for example, records the operation status of forklifts and pallet jacks in detail. This makes it possible to evaluate the accuracy and speed of operations. In addition, it is possible to acquire biological information such as heart rate and stress level using sensors and monitor the worker's health condition in real time.

Next, the analysis unit will be described. The analysis unit is provided in the server and analyzes the collected data using advanced natural language processing technology and machine learning algorithms. Specifically, it analyzes the work patterns of workers and analyzes past work history and success rates in detail to identify workers who complete specific tasks quickly and accurately. For example, it identifies a worker who completes a specific picking task in a short time and evaluates that worker's skill. In addition, it analyzes the operation logs of equipment to identify workers who are skilled in the operation of specific equipment and evaluates the accuracy and speed of operations. Furthermore, by analyzing the worker's biological information and evaluating stress levels and fatigue levels, it is possible to grasp the worker's health condition and propose appropriate breaks.

Furthermore, when the analysis unit determines that the proficiency level regarding a specific equipment operation is less than a reference value, the system transmits a signal to a control unit of the target equipment (e.g., a forklift) to perform control such as limiting the maximum speed of the equipment or locking a specific advanced operation mode. Conversely, for a worker determined to have a high proficiency level, these restrictions are released. In this way, this system not only presents information but also directly changes the operation parameters of physical equipment based on the analysis result, thereby actively controlling the safety of the site.

Regarding the weighting unit, it performs weighting of tasks for each worker based on the importance and urgency of the work and the worker's past performance data. Specifically, urgent shipping tasks and tasks related to important orders from specific customers are set with high priority. In addition, a higher weight is given to a worker who has successfully completed a similar task in the past, and the possibility of that worker being in charge of that task again increases. Furthermore, it is possible to perform reasonable task assignment by considering the worker's current workload and health condition. For example, by assigning a light-load task to a worker with a high fatigue level, it is possible to maintain work efficiency while protecting the worker's health.

Regarding the comparison unit, it compares the skills and performance of a worker with other workers and provides data for performing optimal task assignment. Specifically, when a plurality of workers have the same skill, the most suitable worker is selected by considering past performance data and the current workload. In addition, it is also possible to analyze the worker's skill set and propose an appropriate training program if a specific skill is lacking. For example, when the operation of new equipment is required, by selecting a worker skilled in the operation of that equipment and conducting training for other workers, the overall skill level can be improved.

Regarding the generation unit, it automatically generates an instruction for task assignment for each worker based on the analysis result. As a specific example of a prompt sentence to be read into a generative AI, by using a prompt sentence such as “This worker is skilled in the operation of a forklift. Please assign the next load moving task to him,” the generative AI can generate an accurate task assignment instruction. Furthermore, by using a prompt sentence such as “This worker has a track record of quickly completing urgent shipping tasks in the past. Please assign the next urgent shipping task to him,” it becomes possible to appropriately assign urgent tasks.

In this way, by objectively evaluating the capabilities of workers in a distribution center and realizing efficient task assignment, it is possible to optimize logistics operations. This is expected to improve the productivity and reduce the costs of the distribution center.

### (System Configuration)

The system according to the present embodiment includes an input unit, an analysis unit, a weighting unit, a comparison unit, and a generation unit. The input unit has a function of collecting various data in real time through wearable devices and mobile terminals worn by workers. Specifically, it is possible to acquire the position information of a worker using GPS or beacon technology and track the worker's movement route in detail. This makes it possible to grasp how the worker is moving within the warehouse and analyze efficient flow lines. In addition, it accurately records work time and grasps how much time is spent on each task. Furthermore, by collecting operation logs of the equipment used and, for example, recording the operation status of forklifts and pallet jacks in detail, it is possible to evaluate the accuracy and speed of operations. In addition, it is possible to acquire biological information such as heart rate and stress level using sensors and monitor the worker's health condition in real time.

The analysis unit is provided in the server and analyzes the collected data using advanced natural language processing technology and machine learning algorithms. Specifically, it analyzes the work patterns of workers and analyzes past work history and success rates in detail to identify workers who complete specific tasks quickly and accurately. For example, it identifies a worker who completes a specific picking task in a short time and evaluates that worker's skill. In addition, it analyzes the operation logs of equipment to identify workers who are skilled in the operation of specific equipment and evaluates the accuracy and speed of operations. Furthermore, by analyzing the worker's biological information and evaluating stress levels and fatigue levels, it is possible to grasp the worker's health condition and propose appropriate breaks.

The weighting unit performs weighting of tasks for each worker based on the importance and urgency of the work and the worker's past performance data. Specifically, urgent shipping tasks and tasks related to important orders from specific customers are set with high priority. In addition, a higher weight is given to a worker who has successfully completed a similar task in the past, and the possibility of that worker being in charge of that task again increases. Furthermore, it is possible to perform reasonable task assignment by considering the worker's current workload and health condition. For example, by assigning a light-load task to a worker with a high fatigue level, it is possible to maintain work efficiency while protecting the worker's health.

The comparison unit compares the skills and performance of a worker with other workers and provides data for performing optimal task assignment. Specifically, when a plurality of workers have the same skill, the most suitable worker is selected by considering past performance data and the current workload. In addition, it is also possible to analyze the worker's skill set and propose an appropriate training program if a specific skill is lacking. For example, when the operation of new equipment is required, by selecting a worker skilled in the operation of that equipment and conducting training for other workers, the overall skill level can be improved.

The generation unit automatically generates an instruction for task assignment for each worker based on the analysis result. As a specific example of a prompt sentence to be read into a generative AI, by using a prompt sentence such as “This worker is skilled in the operation of a forklift. Please assign the next load moving task to him,” the generative AI can generate an accurate task assignment instruction. Furthermore, by using a prompt sentence such as “This worker has a track record of quickly completing urgent shipping tasks in the past. Please assign the next urgent shipping task to him,” it becomes possible to appropriately assign urgent tasks.

In this way, by objectively evaluating the capabilities of workers in a distribution center and realizing efficient task assignment, it is possible to optimize logistics operations. This is expected to improve the productivity and reduce the costs of the distribution center.

### IMPLEMENTATION STEPS

### Step 1: Data Collection

The first step is to collect data using a worker's terminal or wearable device. The worker wears a device equipped with GPS or beacon technology to acquire position information, and the movement route is tracked in real time. This makes it possible to grasp in detail how the worker is moving within the warehouse. In addition, work time is accurately recorded, and the time taken for each task is measured. Furthermore, operation logs of equipment such as forklifts and pallet jacks are collected, and data for evaluating the accuracy and speed of operations is acquired. In addition, biological information such as heart rate and stress level is acquired using sensors, and the worker's health condition is monitored in real time.

### Step 2: Data Analysis

The next step is to analyze the collected data. An analysis unit provided in the server identifies the worker's work patterns and skills using natural language processing technology and machine learning algorithms. Specifically, it analyzes past work history and success rates to identify workers who complete specific tasks quickly and accurately. In addition, it analyzes equipment operation logs to identify workers who are skilled in the operation of specific equipment. Furthermore, by analyzing the worker's biological information and evaluating stress levels and fatigue levels, it is possible to grasp the worker's health condition and propose appropriate breaks.

### Step 3: Weighting

This is the step of performing weighting of tasks for each worker based on the analyzed data. The weighting unit sets the priority of tasks by considering the importance and urgency of the work and the worker's past performance data. For example, urgent shipping tasks and tasks related to important orders are set with high priority. In addition, a higher weight is given to a worker who has successfully completed a similar task in the past. Furthermore, it is possible to perform reasonable task assignment by considering the worker's current workload and health condition.

### Step 4: Comparative Analysis

The next step is to compare the skills and performance of a worker with other workers. The comparison unit, when a plurality of workers have the same skill, selects the most suitable worker by considering past performance data and the current workload. In addition, it is also possible to analyze the worker's skill set and propose an appropriate training program if a specific skill is lacking.

### Step 5: Generation of Task Assignment Instruction

The final step is to automatically generate an instruction for task assignment for each worker based on the analysis result. The generation unit generates an accurate task assignment instruction using a prompt sentence to be read into a generative AI. As a specific example, by using a prompt sentence such as “This worker is skilled in the operation of a forklift. Please assign the next load moving task to him,” the generative AI can generate an appropriate instruction. In addition, by using a prompt sentence such as “This worker has a track record of quickly completing urgent shipping tasks in the past. Please assign the next urgent shipping task to him,” it becomes possible to appropriately assign urgent tasks.

### (Specific Use Case)

For example, in a certain distribution center, by introducing the system of the present disclosure, it is possible to improve work efficiency and reduce costs. In this distribution center, many workers perform product picking, packing, and shipping tasks on a daily basis. The workers wear wearable devices, and position information, work time, operation logs of equipment used, and biological information are collected in real time. This makes it possible to grasp the workers' flow lines and work patterns in detail.

The analysis unit uses the collected data to identify the workers' work patterns and skills. For example, it identifies a worker who completes a specific task quickly and accurately and evaluates that worker's skill. In addition, it identifies a worker who is skilled in the operation of a forklift and evaluates the accuracy and speed of the operation. Furthermore, by analyzing the worker's biological information and evaluating stress levels and fatigue levels, it is possible to grasp the worker's health condition and propose appropriate breaks.

The weighting unit performs weighting of tasks for each worker based on the importance and urgency of the work and the worker's past performance data. For example, urgent shipping tasks and tasks related to important orders are set with high priority. In addition, a higher weight is given to a worker who has successfully completed a similar task in the past. Furthermore, it is possible to perform reasonable task assignment by considering the worker's current workload and health condition.

The comparison unit compares the skills and performance of a worker with other workers and provides data for performing optimal task assignment. For example, when a plurality of workers have the same skill, the most suitable worker is selected by considering past performance data and the current workload. In addition, it is also possible to analyze the worker's skill set and propose an appropriate training program if a specific skill is lacking.

The generation unit automatically generates an instruction for task assignment for each worker based on the analysis result. As a specific example of a prompt sentence to be read into a generative AI, by using a prompt sentence such as “This worker is skilled in the operation of a forklift. Please assign the next load moving task to him,” the generative AI can generate an accurate task assignment instruction. In addition, by using a prompt sentence such as “This worker has a track record of quickly completing urgent shipping tasks in the past. Please assign the next urgent shipping task to him,” it becomes possible to appropriately assign urgent tasks.

In this way, by introducing the system of the present disclosure into a distribution center, it is possible to objectively evaluate the capabilities of workers and realize efficient task assignment. This is expected to improve the productivity and reduce the costs of the distribution center.

The specific processing unit 290 transmits a result of the specific processing to the smart device 14. In the smart device 14, the control unit 46A causes the output device 40 to output the result of the specific processing. The microphone 38B acquires voice indicating a user input for the result of the specific processing. The control unit 46A transmits voice data indicating the user input acquired by the microphone 38B to the data processing apparatus 12. In the data processing apparatus 12, the specific processing unit 290 acquires the voice data.

The data generation model 58 is a so-called generative AI (Artificial Intelligence). An example of the data generation model 58 includes a generative AI such as ChatGPT (registered trademark) (Internet search <URL: https://openai.com/blog/chatgpt>). The data generation model 58 is obtained by causing a neural network to perform deep learning. A prompt including an instruction is input to the data generation model 58, and inference data such as voice data indicating voice, text data indicating text, and image data indicating an image (for example, still image data or moving image data) is input. The data generation model 58 infers the input inference data in accordance with the instruction indicated by the prompt, and outputs an inference result in one or more data formats among voice data, text data, image data, and the like. The data generation model 58 includes, for example, a text generation AI, an image generation AI, a multimodal generation AI, and the like. Here, inference refers to, for example, analysis, classification, prediction, and/or summarization, and the like. The specific processing unit 290 performs the above-described specific processing while using the data generation model 58. The data generation model 58 may be a model fine-tuned to output an inference result from a prompt that does not include an instruction, and in this case, the data generation model 58 can output an inference result from a prompt that does not include an instruction. In the data processing apparatus 12 and the like, a plurality of types of data generation models 58 are included, and the data generation model 58 includes AIs other than generative AI. AIs other than generative AI are, for example, linear regression, logistic regression, a decision tree, a random forest, a support vector machine (SVM), k-means clustering, a convolutional neural network (CNN), a recurrent neural network (RNN), a generative adversarial network (GAN), or naive Bayes, and can perform various processes, but the present disclosure is not limited to such examples. Also, the AI may be an AI agent. Also, when the processing of each unit described above is performed by an AI, the processing is partially or entirely performed by the AI, but the present disclosure is not limited to such an example. Also, a process implemented by an AI including a generative AI may be replaced with a rule-based process, and a rule-based process may be replaced with a process implemented by an AI including a generative AI.

Also, the processing by the data processing system 10 described above is executed by the specific processing unit 290 of the data processing apparatus 12 or the control unit 46A of the smart device 14, but may also be executed by the specific processing unit 290 of the data processing apparatus 12 and the control unit 46A of the smart device 14. Also, the specific processing unit 290 of the data processing apparatus 12 acquires or collects information necessary for the processing from the smart device 14 or an external device, and the smart device 14 acquires or collects information necessary for the processing from the data processing apparatus 12 or an external device.

For example, a collection unit is realized by the control unit 46A of the smart device 14 or the specific processing unit 290 of the data processing apparatus 12. For example, an acquisition unit acquires step count data using the camera 42 or the communication I/F 44 of the smart device 14, and the data is processed by the specific processing unit 290 of the data processing apparatus 12. For example, an analysis unit is realized by the specific processing unit 290 of the data processing apparatus 12, and analyzes data from the collection unit and the acquisition unit. For example, a generation unit is realized by the specific processing unit 290 of the data processing apparatus 12, and generates a cooking menu using a generative AI. For example, a provision unit is realized by the output device 40 of the smart device 14 or the specific processing unit 290 of the data processing apparatus 12, and provides the generated cooking menu to a user. The correspondence relationship between each unit and the device or the control unit is not limited to the above-described example, and various changes are possible.

In the above embodiment, an example form in which the specific processing is performed by the data processing apparatus 12 has been described, but the technology of the present disclosure is not limited to this, and the specific processing may be performed by the smart device 14.

### Second Embodiment

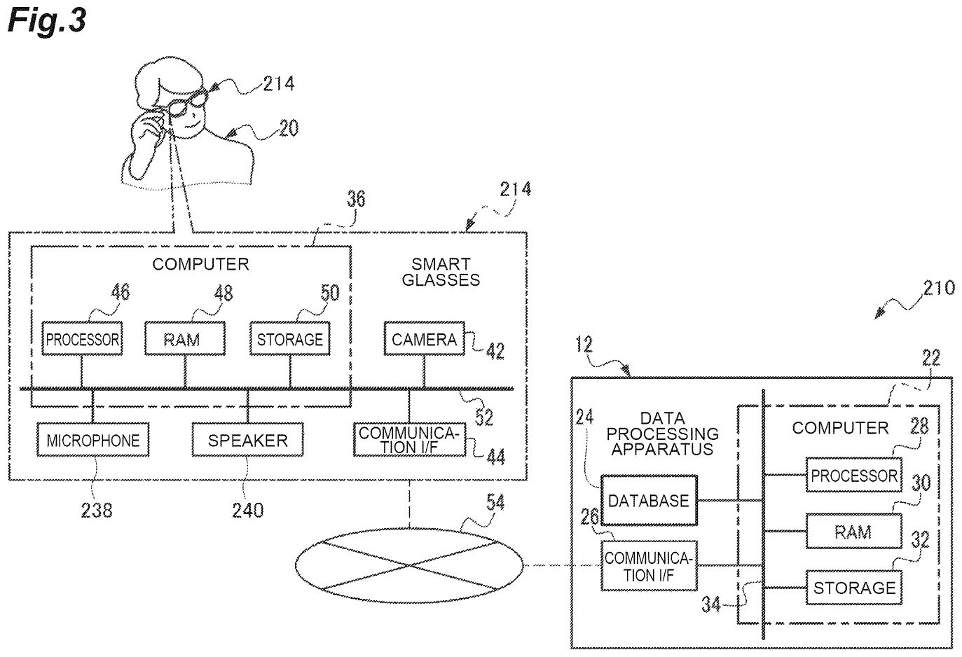

FIG. 3 illustrates an example of a configuration of a data processing system 210 according to a second embodiment.

As illustrated in FIG. 3, the data processing system 210 includes a data processing apparatus 12 and smart glasses 214. An example of the data processing apparatus 12 includes a server.

The data processing apparatus 12 includes a computer 22, a database 24, and a communication I/F 26. The computer 22 is an example of a “computer” according to the technology of the present disclosure. The computer 22 includes a processor 28, a RAM 30, and a storage 32. The processor 28, the RAM 30, and the storage 32 are connected to a bus 34. Also, the database 24 and the communication I/F 26 are also connected to the bus 34. The communication I/F 26 is connected to a network 54. An example of the network 54 includes a WAN (Wide Area Network) and/or a LAN (Local Area Network), and the like.

The smart glasses 214 include a computer 36, a microphone 238, a speaker 240, a camera 42, and a communication I/F 44. The computer 36 includes a processor 46, a RAM 48, and a storage 50. The processor 46, the RAM 48, and the storage 50 are connected to a bus 52. Also, the microphone 238, the speaker 240, and the camera 42 are also connected to the bus 52.

The microphone 238 receives an instruction or the like from a user 20 by receiving voice uttered by the user 20. The microphone 238 captures the voice uttered by the user 20, converts the captured voice into voice data, and outputs the voice data to the processor 46. The speaker 240 outputs voice in accordance with an instruction from the processor 46.

The camera 42 is a small digital camera on which an optical system such as a lens, a diaphragm, and a shutter, and an image sensor such as a CMOS (Complementary Metal-Oxide-Semiconductor) image sensor or a CCD (Charge Coupled Device) image sensor are mounted, and images the surroundings of the user 20 (for example, an imaging range defined by an angle of view corresponding to the width of the field of view of a general person with normal vision).

The communication I/F 44 is connected to the network 54. The communication I/Fs 44 and 26 manage exchange of various information between the processor 46 and the processor 28 via the network 54. The exchange of various information between the processor 46 and the processor 28 using the communication I/Fs 44 and 26 is performed in a secure state.

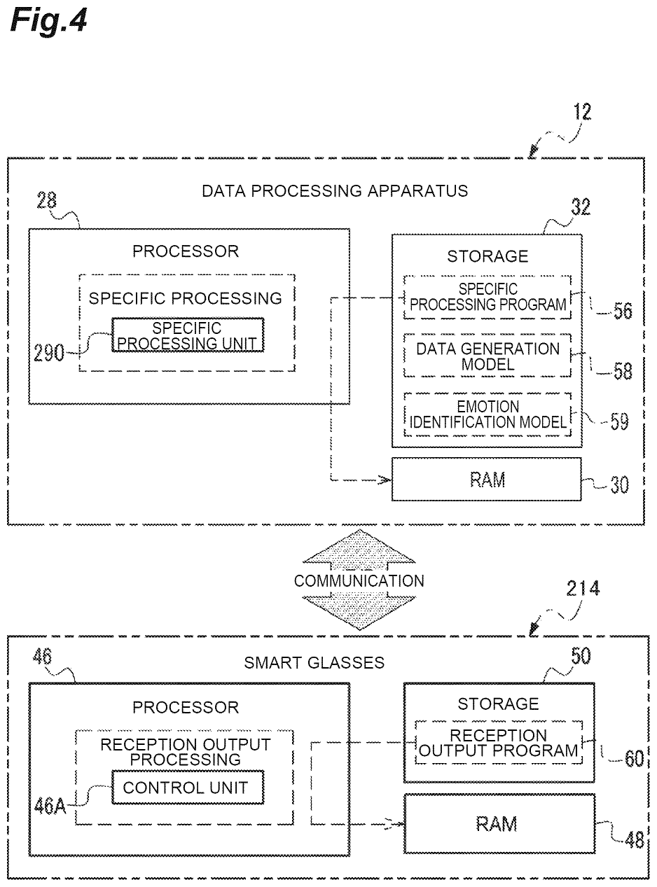

FIG. 4 illustrates an example of main functions of the data processing apparatus 12 and the smart glasses 214. As illustrated in FIG. 4, in the data processing apparatus 12, specific processing is performed by the processor 28. A specific processing program 56 is stored in the storage 32.

The specific processing program 56 is an example of a “program” according to the technology of the present disclosure. The processor 28 reads the specific processing program 56 from the storage 32 and executes the read specific processing program 56 on the RAM 30. The specific processing is realized by the processor 28 operating as a specific processing unit 290 in accordance with the specific processing program 56 executed on the RAM 30.

A data generation model 58 and an emotion identification model 59 are stored in the storage 32. The data generation model 58 and the emotion identification model 59 are used by the specific processing unit 290. The specific processing unit 290 can estimate a user's emotion using the emotion identification model 59 and perform specific processing using the user's emotion. In an emotion estimation function (emotion identification function) using the emotion identification model 59, various estimations and predictions regarding the user's emotion, including estimation and prediction of the user's emotion, are performed, but the present disclosure is not limited to such an example. Also, the estimation and prediction of emotion include, for example, analysis (analytics) of emotion and the like.

In the smart glasses 214, reception output processing is performed by the processor 46. A reception output program 60 is stored in the storage 50. The processor 46 reads the reception output program 60 from the storage 50 and executes the read reception output program 60 on the RAM 48. The reception output processing is realized by the processor 46 operating as a control unit 46A in accordance with the reception output program 60 executed on the RAM 48. Note that the smart glasses 214 can also have a data generation model and an emotion identification model similar to the data generation model 58 and the emotion identification model 59, and perform processing similar to that of the specific processing unit 290 using these models.

Next, specific processing by the specific processing unit 290 of the data processing apparatus 12 will be described. Each unit of the system described below is realized by the data processing apparatus 12 and the smart glasses 214. In the following description, the data processing apparatus 12 is referred to as a “server”, and the smart glasses 214 are referred to as a “terminal”.

### Example 1

Since the flow of the specific processing is the same as that in Example 1 described in the first embodiment, a description thereof is omitted.

### Application Example 1

Since the flow of the specific processing is the same as that in Example 1 described in the first embodiment, a description thereof is omitted.

The specific processing unit 290 transmits a result of the specific processing to the smart glasses 214. In the smart glasses 214, the control unit 46A causes the speaker 240 to output the result of the specific processing. The microphone 238 acquires voice indicating a user input for the result of the specific processing. The control unit 46A transmits voice data indicating the user input acquired by the microphone 238 to the data processing apparatus 12. In the data processing apparatus 12, the specific processing unit 290 acquires the voice data.

The data generation model 58 is a so-called generative AI (Artificial Intelligence). An example of the data generation model 58 includes a generative AI such as ChatGPT (registered trademark) (Internet search <URL: https://openai.com/blog/chatgpt>). The data generation model 58 is obtained by causing a neural network to perform deep learning. A prompt including an instruction is input to the data generation model 58, and inference data such as voice data indicating voice, text data indicating text, and image data indicating an image (for example, still image data or moving image data) is input. The data generation model 58 infers the input inference data in accordance with the instruction indicated by the prompt, and outputs an inference result in one or more data formats among voice data, text data, image data, and the like. The data generation model 58 includes, for example, a text generation AI, an image generation AI, a multimodal generation AI, and the like. Here, inference refers to, for example, analysis, classification, prediction, and/or summarization, and the like. The specific processing unit 290 performs the above-described specific processing while using the data generation model 58. The data generation model 58 may be a model fine-tuned to output an inference result from a prompt that does not include an instruction, and in this case, the data generation model 58 can output an inference result from a prompt that does not include an instruction. In the data processing apparatus 12 and the like, a plurality of types of data generation models 58 are included, and the data generation model 58 includes AIs other than generative AI. AIs other than generative AI are, for example, linear regression, logistic regression, a decision tree, a random forest, a support vector machine (SVM), k-means clustering, a convolutional neural network (CNN), a recurrent neural network (RNN), a generative adversarial network (GAN), or naive Bayes, and can perform various processes, but the present disclosure is not limited to such examples. Also, the AI may be an AI agent. Also, when the processing of each unit described above is performed by an AI, the processing is partially or entirely performed by the AI, but the present disclosure is not limited to such an example. Also, a process implemented by an AI including a generative AI may be replaced with a rule-based process, and a rule-based process may be replaced with a process implemented by an AI including a generative AI.

Also, the processing by the data processing system 10 described above is executed by the specific processing unit 290 of the data processing apparatus 12 or the control unit 46A of the smart device 14, but may also be executed by the specific processing unit 290 of the data processing apparatus 12 and the control unit 46A of the smart device 14. Also, the specific processing unit 290 of the data processing apparatus 12 acquires or collects information necessary for the processing from the smart device 14 or an external device, and the smart device 14 acquires or collects information necessary for the processing from the data processing apparatus 12 or an external device.

For example, a collection unit is realized by the control unit 46A of the smart device 14 or the specific processing unit 290 of the data processing apparatus 12. For example, an acquisition unit acquires step count data using the camera 42 or the communication I/F 44 of the smart device 14, and the data is processed by the specific processing unit 290 of the data processing apparatus 12. For example, an analysis unit is realized by the specific processing unit 290 of the data processing apparatus 12, and analyzes data from the collection unit and the acquisition unit. For example, a generation unit is realized by the specific processing unit 290 of the data processing apparatus 12, and generates a cooking menu using a generative AI. For example, a provision unit is realized by the output device 40 of the smart device 14 or the specific processing unit 290 of the data processing apparatus 12, and provides the generated cooking menu to a user. The correspondence relationship between each unit and the device or the control unit is not limited to the above-described example, and various changes are possible.

In the above embodiment, an example form in which the specific processing is performed by the data processing apparatus 12 has been described, but the technology of the present disclosure is not limited to this, and the specific processing may be performed by the smart glasses 214.

### Third Embodiment

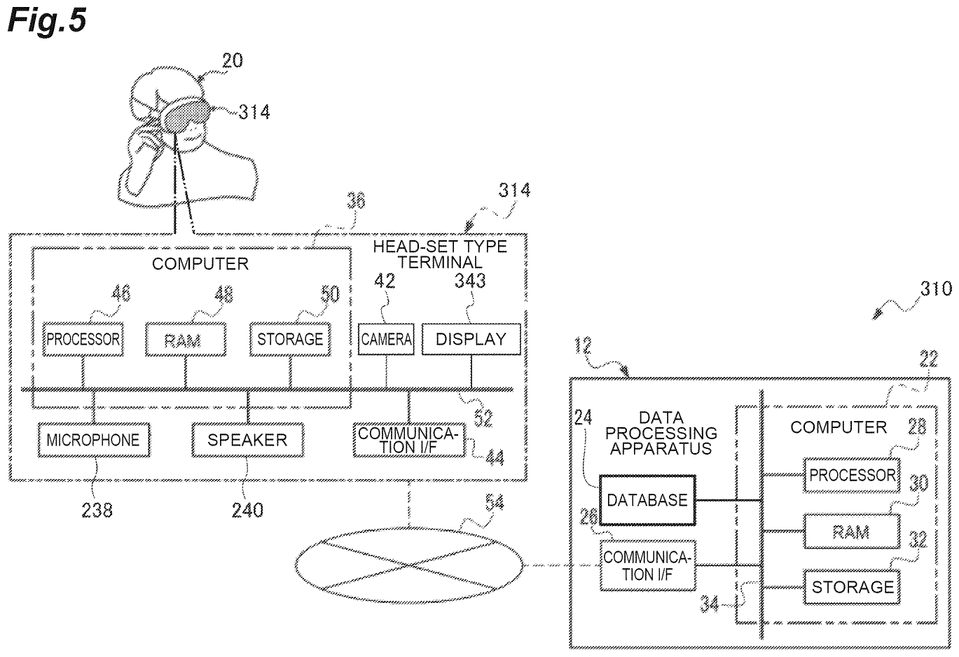

FIG. 5 illustrates an example of a configuration of a data processing system 310 according to a third embodiment.

As illustrated in FIG. 5, the data processing system 310 includes a data processing apparatus 12 and a headset-type terminal 314. An example of the data processing apparatus 12 includes a server.

The data processing apparatus 12 includes a computer 22, a database 24, and a communication I/F 26. The computer 22 is an example of a “computer” according to the technology of the present disclosure. The computer 22 includes a processor 28, a RAM 30, and a storage 32. The processor 28, the RAM 30, and the storage 32 are connected to a bus 34. Also, the database 24 and the communication I/F 26 are also connected to the bus 34. The communication I/F 26 is connected to a network 54. An example of the network 54 includes a WAN (Wide Area Network) and/or a LAN (Local Area Network), and the like.

The headset-type terminal 314 includes a computer 36, a microphone 238, a speaker 240, a camera 42, a communication I/F 44, and a display 343. The computer 36 includes a processor 46, a RAM 48, and a storage 50. The processor 46, the RAM 48, and the storage 50 are connected to a bus 52. Also, the microphone 238, the speaker 240, the camera 42, and the display 343 are also connected to the bus 52.

The microphone 238 receives an instruction or the like from a user 20 by receiving voice uttered by the user 20. The microphone 238 captures the voice uttered by the user 20, converts the captured voice into voice data, and outputs the voice data to the processor 46. The speaker 240 outputs voice in accordance with an instruction from the processor 46.

The camera 42 is a small digital camera on which an optical system such as a lens, a diaphragm, and a shutter, and an image sensor such as a CMOS (Complementary Metal-Oxide-Semiconductor) image sensor or a CCD (Charge Coupled Device) image sensor are mounted, and images the surroundings of the user 20 (for example, an imaging range defined by an angle of view corresponding to the width of the field of view of a general person with normal vision).

The communication I/F 44 is connected to the network 54. The communication I/Fs 44 and 26 manage exchange of various information between the processor 46 and the processor 28 via the network 54. The exchange of various information between the processor 46 and the processor 28 using the communication I/Fs 44 and 26 is performed in a secure state.

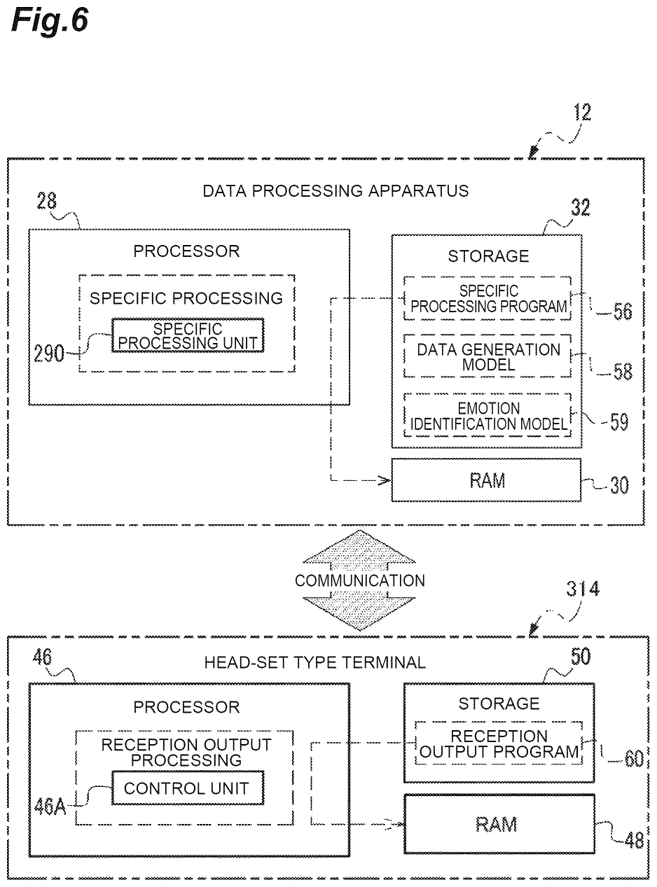

FIG. 6 illustrates an example of main functions of the data processing apparatus 12 and the headset-type terminal 314. As illustrated in FIG. 6, in the data processing apparatus 12, specific processing is performed by the processor 28. A specific processing program 56 is stored in the storage 32.

The specific processing program 56 is an example of a “program” according to the technology of the present disclosure. The processor 28 reads the specific processing program 56 from the storage 32 and executes the read specific processing program 56 on the RAM 30. The specific processing is realized by the processor 28 operating as a specific processing unit 290 in accordance with the specific processing program 56 executed on the RAM 30.

A data generation model 58 and an emotion identification model 59 are stored in the storage 32. The data generation model 58 and the emotion identification model 59 are used by the specific processing unit 290.

In the headset-type terminal 314, reception output processing is performed by the processor 46. A reception output program 60 is stored in the storage 50. The processor 46 reads the reception output program 60 from the storage 50 and executes the read reception output program 60 on the RAM 48. The reception output processing is realized by the processor 46 operating as a control unit 46A in accordance with the reception output program 60 executed on the RAM 48.

Next, specific processing by the specific processing unit 290 of the data processing apparatus 12 will be described. Each unit of the system described below is realized by the data processing apparatus 12 and the headset-type terminal 314. In the following description, the data processing apparatus 12 is referred to as a “server”, and the headset-type terminal 314 is referred to as a “terminal”.

### Example 1

Since the flow of the specific processing is the same as that in Example 1 described in the first embodiment, a description thereof is omitted.

### Application Example 1

Since the flow of the specific processing is the same as that in Example 1 described in the first embodiment, a description thereof is omitted.

The specific processing unit 290 transmits a result of the specific processing to the headset-type terminal 314. In the headset-type terminal 314, the control unit 46A causes the speaker 240 and the display 343 to output the result of the specific processing. The microphone 238 acquires voice indicating a user input for the result of the specific processing. The control unit 46A transmits voice data indicating the user input acquired by the microphone 238 to the data processing apparatus 12. In the data processing apparatus 12, the specific processing unit 290 acquires the voice data.

The data generation model 58 is a so-called generative AI (Artificial Intelligence). An example of the data generation model 58 includes a generative AI such as ChatGPT (registered trademark) (Internet search <URL: https://openai.com/blog/chatgpt>). The data generation model 58 is obtained by causing a neural network to perform deep learning. A prompt including an instruction is input to the data generation model 58, and inference data such as voice data indicating voice, text data indicating text, and image data indicating an image (for example, still image data or moving image data) is input. The data generation model 58 infers the input inference data in accordance with the instruction indicated by the prompt, and outputs an inference result in one or more data formats among voice data, text data, image data, and the like. The data generation model 58 includes, for example, a text generation AI, an image generation AI, a multimodal generation AI, and the like. Here, inference refers to, for example, analysis, classification, prediction, and/or summarization, and the like. The specific processing unit 290 performs the above-described specific processing while using the data generation model 58. The data generation model 58 may be a model fine-tuned to output an inference result from a prompt that does not include an instruction, and in this case, the data generation model 58 can output an inference result from a prompt that does not include an instruction. In the data processing apparatus 12 and the like, a plurality of types of data generation models 58 are included, and the data generation model 58 includes AIs other than generative AI. AIs other than generative AI are, for example, linear regression, logistic regression, a decision tree, a random forest, a support vector machine (SVM), k-means clustering, a convolutional neural network (CNN), a recurrent neural network (RNN), a generative adversarial network (GAN), or naive Bayes, and can perform various processes, but the present disclosure is not limited to such examples. Also, the AI may be an AI agent. Also, when the processing of each unit described above is performed by an AI, the processing is partially or entirely performed by the AI, but the present disclosure is not limited to such an example. Also, a process implemented by an AI including a generative AI may be replaced with a rule-based process, and a rule-based process may be replaced with a process implemented by an AI including a generative AI.

Also, the processing by the data processing system 10 described above is executed by the specific processing unit 290 of the data processing apparatus 12 or the control unit 46A of the smart device 14, but may also be executed by the specific processing unit 290 of the data processing apparatus 12 and the control unit 46A of the smart device 14. Also, the specific processing unit 290 of the data processing apparatus 12 acquires or collects information necessary for the processing from the smart device 14 or an external device, and the smart device 14 acquires or collects information necessary for the processing from the data processing apparatus 12 or an external device.

For example, a collection unit is realized by the control unit 46A of the smart device 14 or the specific processing unit 290 of the data processing apparatus 12. For example, an acquisition unit acquires step count data using the camera 42 or the communication I/F 44 of the smart device 14, and the data is processed by the specific processing unit 290 of the data processing apparatus 12. For example, an analysis unit is realized by the specific processing unit 290 of the data processing apparatus 12, and analyzes data from the collection unit and the acquisition unit. For example, a generation unit is realized by the specific processing unit 290 of the data processing apparatus 12, and generates a cooking menu using a generative AI. For example, a provision unit is realized by the output device 40 of the smart device 14 or the specific processing unit 290 of the data processing apparatus 12, and provides the generated cooking menu to a user. The correspondence relationship between each unit and the device or the control unit is not limited to the above-described example, and various changes are possible.

In the above embodiment, an example form in which the specific processing is performed by the data processing apparatus 12 has been described, but the technology of the present disclosure is not limited to this, and the specific processing may be performed by the headset-type terminal 314.

### Fourth Embodiment

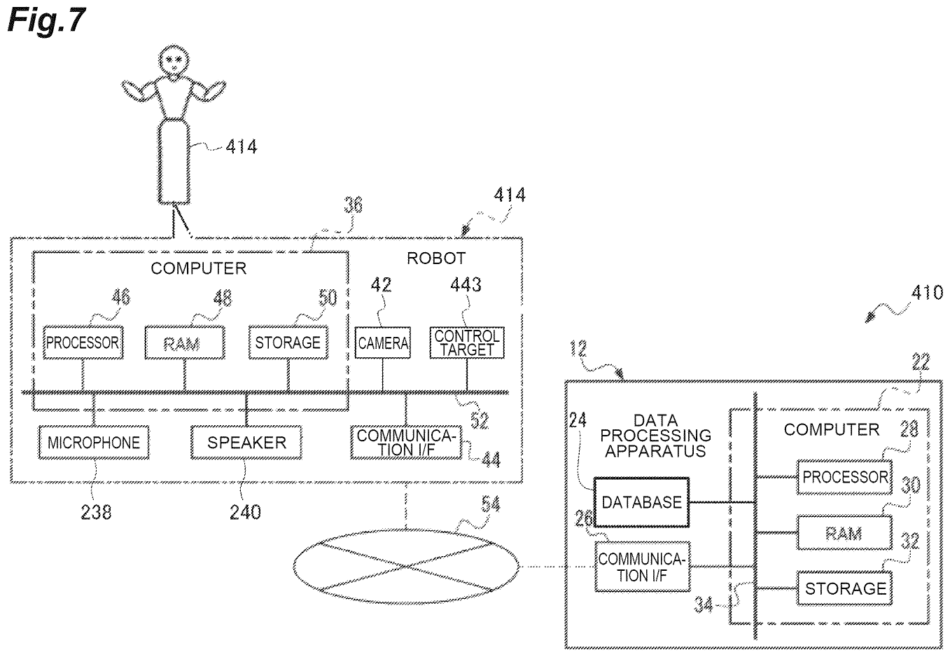

FIG. 7 illustrates an example of a configuration of a data processing system 410 according to a fourth embodiment.

As illustrated in FIG. 7, the data processing system 410 includes a data processing apparatus 12 and a robot 414. An example of the data processing apparatus 12 includes a server.

The data processing apparatus 12 includes a computer 22, a database 24, and a communication I/F 26. The computer 22 is an example of a “computer” according to the technology of the present disclosure. The computer 22 includes a processor 28, a RAM 30, and a storage 32. The processor 28, the RAM 30, and the storage 32 are connected to a bus 34. Also, the database 24 and the communication I/F 26 are also connected to the bus 34. The communication I/F 26 is connected to a network 54. An example of the network 54 includes a WAN (Wide Area Network) and/or a LAN (Local Area Network), and the like.

The robot 414 includes a computer 36, a microphone 238, a speaker 240, a camera 42, a communication I/F 44, and a control target 443. The computer 36 includes a processor 46, a RAM 48, and a storage 50. The processor 46, the RAM 48, and the storage 50 are connected to a bus 52. Also, the microphone 238, the speaker 240, the camera 42, and the control target 443 are also connected to the bus 52.

The microphone 238 receives an instruction or the like from a user 20 by receiving voice uttered by the user 20. The microphone 238 captures the voice uttered by the user 20, converts the captured voice into voice data, and outputs the voice data to the processor 46. The speaker 240 outputs voice in accordance with an instruction from the processor 46.

The camera 42 is a small digital camera on which an optical system such as a lens, a diaphragm, and a shutter, and an image sensor such as a CMOS (Complementary Metal-Oxide-Semiconductor) image sensor or a CCD (Charge Coupled Device) image sensor are mounted, and images the surroundings of the user 20 (for example, an imaging range defined by an angle of view corresponding to the width of the field of view of a general person with normal vision).

The communication I/F 44 is connected to the network 54. The communication I/Fs 44 and 26 manage exchange of various information between the processor 46 and the processor 28 via the network 54. The exchange of various information between the processor 46 and the processor 28 using the communication I/Fs 44 and 26 is performed in a secure state.

The control target 443 includes a display device, an LED of an eye part, and motors that drive an arm, a hand, a leg, and the like. The posture and gestures of the robot 414 are controlled by controlling the motors of the arm, hand, leg, and the like. A part of the emotions of the robot 414 can be expressed by controlling these motors. Also, the facial expression of the robot 414 can also be expressed by controlling the light emission state of the LED of the eye part of the robot 414.

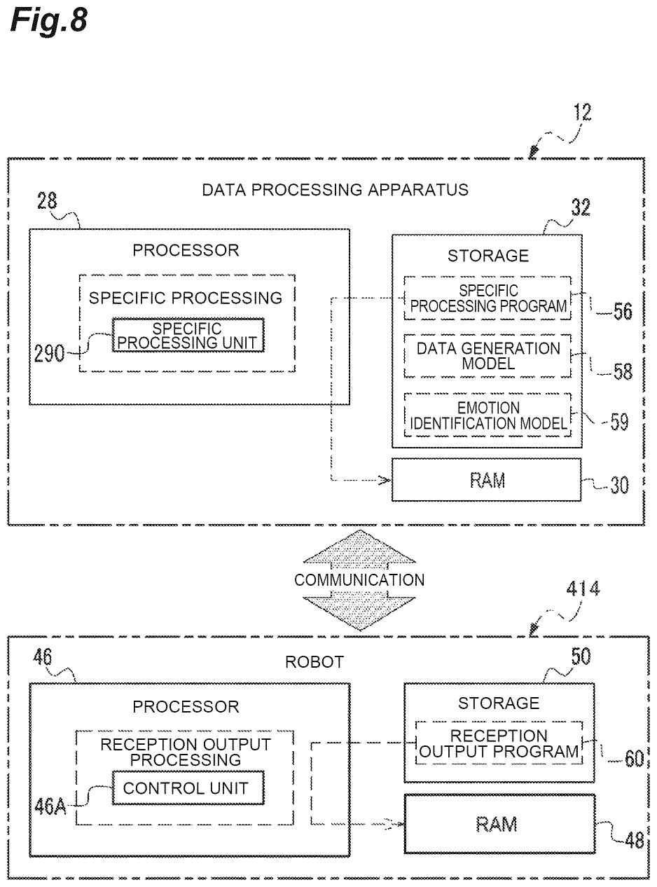

FIG. 8 illustrates an example of main functions of the data processing apparatus 12 and the robot 414. As illustrated in FIG. 8, in the data processing apparatus 12, specific processing is performed by the processor 28. A specific processing program 56 is stored in the storage 32.

The specific processing program 56 is an example of a “program” according to the technology of the present disclosure. The processor 28 reads the specific processing program 56 from the storage 32 and executes the read specific processing program 56 on the RAM 30. The specific processing is realized by the processor 28 operating as a specific processing unit 290 in accordance with the specific processing program 56 executed on the RAM 30.

A data generation model 58 and an emotion identification model 59 are stored in the storage 32. The data generation model 58 and the emotion identification model 59 are used by the specific processing unit 290.

In the robot 414, reception output processing is performed by the processor 46. A reception output program 60 is stored in the storage 50. The processor 46 reads the reception output program 60 from the storage 50 and executes the read reception output program 60 on the RAM 48. The reception output processing is realized by the processor 46 operating as a control unit 46A in accordance with the reception output program 60 executed on the RAM 48.

Next, specific processing by the specific processing unit 290 of the data processing apparatus 12 will be described. Each unit of the system described below is realized by the data processing apparatus 12 and the robot 414. In the following description, the data processing apparatus 12 is referred to as a “server”, and the robot 414 is referred to as a “terminal”.

### Example 1

Since the flow of the specific processing is the same as that in Example 1 described in the first embodiment, a description thereof is omitted.

### Application Example 1

Since the flow of the specific processing is the same as that in Example 1 described in the first embodiment, a description thereof is omitted.

The specific processing unit 290 transmits a result of the specific processing to the robot 414. In the robot 414, the control unit 46A causes the speaker 240 and the control target 443 to output the result of the specific processing. The microphone 238 acquires voice indicating a user input for the result of the specific processing. The control unit 46A transmits voice data indicating the user input acquired by the microphone 238 to the data processing apparatus 12. In the data processing apparatus 12, the specific processing unit 290 acquires the voice data.

The data generation model 58 is a so-called generative AI (Artificial Intelligence). An example of the data generation model 58 includes a generative AI such as ChatGPT (registered trademark) (Internet search <URL: https://openai.com/blog/chatgpt>). The data generation model 58 is obtained by causing a neural network to perform deep learning. A prompt including an instruction is input to the data generation model 58, and inference data such as voice data indicating voice, text data indicating text, and image data indicating an image (for example, still image data or moving image data) is input. The data generation model 58 infers the input inference data in accordance with the instruction indicated by the prompt, and outputs an inference result in one or more data formats among voice data, text data, image data, and the like. The data generation model 58 includes, for example, a text generation AI, an image generation AI, a multimodal generation AI, and the like. Here, inference refers to, for example, analysis, classification, prediction, and/or summarization, and the like. The specific processing unit 290 performs the above-described specific processing while using the data generation model 58. The data generation model 58 may be a model fine-tuned to output an inference result from a prompt that does not include an instruction, and in this case, the data generation model 58 can output an inference result from a prompt that does not include an instruction. In the data processing apparatus 12 and the like, a plurality of types of data generation models 58 are included, and the data generation model 58 includes AIs other than generative AI. AIs other than generative AI are, for example, linear regression, logistic regression, a decision tree, a random forest, a support vector machine (SVM), k-means clustering, a convolutional neural network (CNN), a recurrent neural network (RNN), a generative adversarial network (GAN), or naive Bayes, and can perform various processes, but the present disclosure is not limited to such examples. Also, the AI may be an AI agent. Also, when the processing of each unit described above is performed by an AI, the processing is partially or entirely performed by the AI, but the present disclosure is not limited to such an example. Also, a process implemented by an AI including a generative AI may be replaced with a rule-based process, and a rule-based process may be replaced with a process implemented by an AI including a generative AI.

Also, the processing by the data processing system 10 described above is executed by the specific processing unit 290 of the data processing apparatus 12 or the control unit 46A of the smart device 14, but may also be executed by the specific processing unit 290 of the data processing apparatus 12 and the control unit 46A of the smart device 14. Also, the specific processing unit 290 of the data processing apparatus 12 acquires or collects information necessary for the processing from the smart device 14 or an external device, and the smart device 14 acquires or collects information necessary for the processing from the data processing apparatus 12 or an external device.

For example, a collection unit is realized by the control unit 46A of the smart device 14 or the specific processing unit 290 of the data processing apparatus 12. For example, an acquisition unit acquires step count data using the camera 42 or the communication I/F 44 of the smart device 14, and the data is processed by the specific processing unit 290 of the data processing apparatus 12. For example, an analysis unit is realized by the specific processing unit 290 of the data processing apparatus 12, and analyzes data from the collection unit and the acquisition unit. For example, a generation unit is realized by the specific processing unit 290 of the data processing apparatus 12, and generates a cooking menu using a generative AI. For example, a provision unit is realized by the output device 40 of the smart device 14 or the specific processing unit 290 of the data processing apparatus 12, and provides the generated cooking menu to a user. The correspondence relationship between each unit and the device or the control unit is not limited to the above-described example, and various changes are possible.

In the above embodiment, an example form in which the specific processing is performed by the data processing apparatus 12 has been described, but the technology of the present disclosure is not limited to this, and the specific processing may be performed by the robot 414.

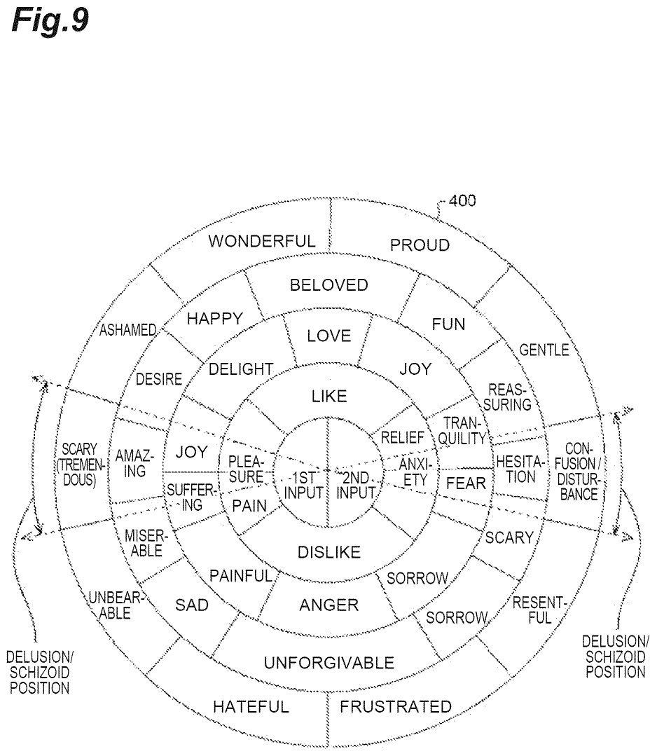

Note that the emotion identification model 59 as an emotion engine may determine a user's emotion according to a specific mapping. Specifically, the emotion identification model 59 may determine the user's emotion according to an emotion map (see FIG. 9), which is a specific mapping. Also, the emotion identification model 59 may similarly determine the robot's emotion, and the specific processing unit 290 may perform specific processing using the robot's emotion.

FIG. 9 is a diagram illustrating an emotion map 400 on which a plurality of emotions are mapped. In the emotion map 400, emotions are arranged in concentric circles radiating from the center. The closer to the center of the concentric circles, the more primitive the state of the emotion is arranged. On the outer side of the concentric circles, emotions representing states and actions arising from a state of mind are arranged. Emotion is a concept that also includes affect and mental states. On the left side of the concentric circles, emotions generated from reactions that generally occur in the brain are arranged. On the right side of the concentric circles, emotions that are generally induced by situational judgment are arranged. In the upward and downward directions of the concentric circles, emotions that are generated from reactions that generally occur in the brain and are induced by situational judgment are arranged. Also, on the upper side of the concentric circles, “pleasant” emotions are arranged, and on the lower side, “unpleasant” emotions are arranged. In this way, in the emotion map 400, a plurality of emotions are mapped based on the structure in which emotions are generated, and emotions that are likely to occur at the same time are mapped close to each other.

These emotions are distributed in the 3 o'clock direction of the emotion map 400, and usually go back and forth between relief and anxiety. In the right half of the emotion map 400, situational awareness is superior to internal sensations, resulting in a calm impression.

Since the inside of the emotion map 400 represents the inside of the mind and the outside of the emotion map 400 represents actions, the further one goes to the outside of the emotion map 400, the more visible (manifested in action) the emotion becomes.

Here, human emotions are based on various balances such as posture and blood sugar levels, and show a state of unpleasantness when those balances move away from the ideal, and a state of pleasantness when they approach the ideal. In robots, automobiles, motorcycles, and the like as well, emotions can be created based on various balances such as posture and remaining battery level, so as to show a state of unpleasantness when those balances move away from the ideal, and a state of pleasantness when they approach the ideal. The emotion map may be generated based on, for example, Dr. Mitsuyoshi's emotion map (Research on a speech emotion recognition and brain physiological signal analysis system of affect, Tokushima University, doctoral dissertation: https://ci.nii.ac.jp/naid/500000375379). In the left half of the emotion map, emotions belonging to a region called “reaction” where sensation is dominant are arranged. Also, in the right half of the emotion map, emotions belonging to a region called “situation” where situational awareness is dominant are arranged.

In the emotion map, two emotions that promote learning are defined. One is an emotion around the middle of negative “remorse” and “reflection” on the situation side. That is, it is when a negative emotion such as “I never want to feel this way again” or “I don't want to be scolded anymore” arises in the robot. The other is an emotion around positive “desire” on the reaction side. That is, it is when there is a positive feeling such as “I want more” or “I want to know more”.

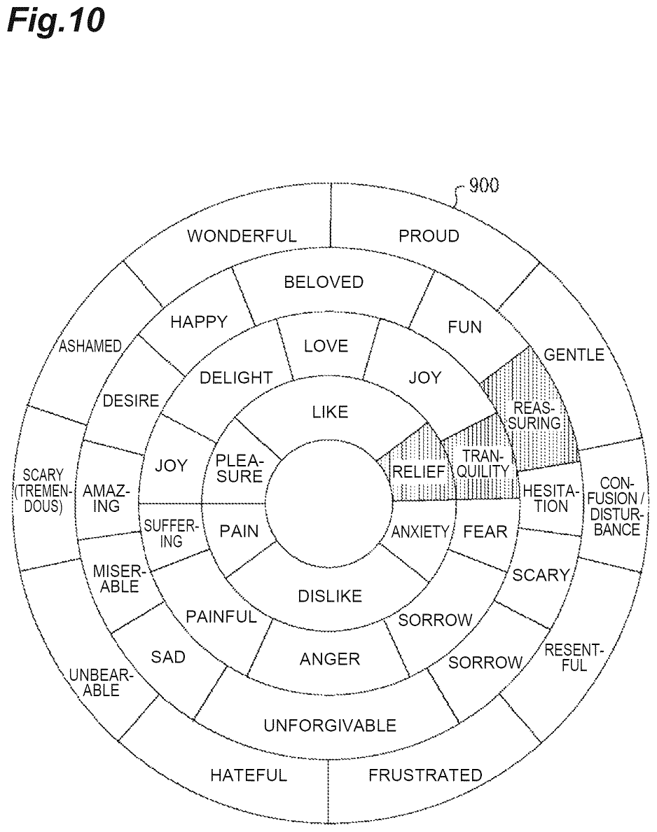

The emotion identification model 59 inputs a user input into a pre-trained neural network, acquires an emotion value indicating each emotion shown in the emotion map 400, and determines the user's emotion. This neural network is pre-trained based on a plurality of learning data that are combinations of user inputs and emotion values indicating each emotion shown in the emotion map 400. Also, this neural network is trained such that emotions arranged close to each other have close values, as in the emotion map 900 shown in FIG. 10. FIG. 10 shows an example in which a plurality of emotions, “relief,” “peace of mind,” and “reassured,” have close emotion values.

Although the system according to the present disclosure has been described above mainly with respect to the functions of the data processing apparatus 12, the system according to the present disclosure is not necessarily implemented in a server. The system according to the present disclosure may be implemented as a general information processing system. The present disclosure may be implemented as, for example, a software program that runs on a personal computer, or an application that runs on a smartphone or the like. The method according to the present disclosure may be provided to a user in a Saas (Software as a Service) format.

In the above embodiment, an example form in which the specific processing is performed by one computer 22 has been described, but the technology of the present disclosure is not limited to this, and distributed processing for the specific processing may be performed by a plurality of computers including the computer 22. For example, the data generation model 58 may be provided in an external device of the data processing apparatus 12, and the external device may generate data according to the input data.

In the above embodiment, an example form in which the specific processing program 56 is stored in the storage 32 has been described, but the technology of the present disclosure is not limited to this. For example, the specific processing program 56 may be stored in a portable computer-readable non-transitory storage medium such as a USB (Universal Serial Bus) memory. The specific processing program 56 stored in the non-transitory storage medium is installed in the computer 22 of the data processing apparatus 12. The processor 28 executes the specific processing according to the specific processing program 56.

Also, the specific processing program 56 may be stored in a storage device such as a server connected to the data processing apparatus 12 via the network 54, and the specific processing program 56 may be downloaded in response to a request from the data processing apparatus 12 and installed in the computer 22.

Note that it is not necessary to store all of the specific processing program 56 in a storage device such as a server connected to the data processing apparatus 12 via the network 54, or to store all of the specific processing program 56 in the storage 32, and a part of the specific processing program 56 may be stored.

As hardware resources for executing the specific processing, various processors shown below can be used. Examples of the processor include a CPU, which is a general-purpose processor that functions as a hardware resource for executing the specific processing by executing software, that is, a program. Also, examples of the processor include a dedicated electric circuit, which is a processor having a circuit configuration specifically designed to execute specific processing, such as an FPGA (Field-Programmable Gate Array), a PLD (Programmable Logic Device), or an ASIC (Application Specific Integrated Circuit). A memory is built in or connected to any of the processors, and any of the processors executes the specific processing by using the memory.

The hardware resource that executes the specific processing may be configured by one of these various processors, or may be configured by a combination of two or more processors of the same type or different types (for example, a combination of a plurality of FPGAs, or a combination of a CPU and an FPGA). Also, the hardware resource that executes the specific processing may be one processor.

As an example of a configuration with one processor, first, there is a form in which one processor is configured by a combination of one or more CPUs and software, and this processor functions as a hardware resource for executing the specific processing. Second, there is a form in which a processor that realizes the functions of an entire system including a plurality of hardware resources for executing the specific processing with one IC chip, as represented by an SoC (System-on-a-chip) or the like, is used. In this way, the specific processing is realized using one or more of the various processors described above as hardware resources.

Furthermore, as a hardware structure of these various processors, more specifically, an electric circuit in which circuit elements such as semiconductor elements are combined can be used. Also, the specific processing described above is merely an example. Therefore, it goes without saying that unnecessary steps may be deleted, new steps may be added, or the processing order may be changed within a scope that does not depart from the gist.

The description and illustrations shown above are detailed descriptions of the parts related to the technology of the present disclosure, and are merely an example of the technology of the present disclosure. For example, the description regarding the above-described configuration, function, operation, and effect is a description regarding an example of the configuration, function, operation, and effect of the part related to the technology of the present disclosure. Therefore, it goes without saying that unnecessary parts may be deleted, new elements may be added, or replacements may be made to the description and illustrations shown above within a scope that does not depart from the gist of the technology of the present disclosure. Also, in order to avoid confusion and facilitate understanding of the parts related to the technology of the present disclosure, in the description and illustrations shown above, descriptions regarding common general technical knowledge and the like that do not require particular explanation for enabling the implementation of the technology of the present disclosure are omitted.

All documents, patent applications, and technical standards described in this specification are incorporated herein by reference to the same extent as if each individual document, patent application, and technical standard were specifically and individually indicated to be incorporated by reference.

Regarding the above embodiments, the following is further disclosed.

### Application Example 1

A system for grasping the capabilities of workers and performing efficient task assignment, the system comprising: an input unit that collects data from a worker's terminal or wearable device; an analysis unit that analyzes the data to identify the worker's work patterns and skills; a weighting unit that performs weighting of tasks for each worker based on the importance and urgency of the work and the worker's past performance data; a comparison unit that compares the worker's skills and performance with other workers based on the analysis result; and a generation unit that automatically generates an instruction for task assignment for each worker based on the result of the comparison.

The system, wherein the analysis unit has a function of identifying a worker who completes a specific task quickly and accurately or a worker who is skilled in the operation of a specific piece of equipment by analyzing the worker's work history and success rate using natural language processing technology and machine learning algorithms.

The system, wherein the generation unit has a function of generating a task assignment instruction based on the worker's skills and past achievements using a prompt sentence to be read into a generative AI, and providing a specific instruction such as, for example, “This worker is skilled in the operation of a forklift. Please assign the next load moving task to him.”

A system for evaluating capabilities of an employee, comprising circuitry configured to: receive an email or a document of the employee as input data; analyze the input data to extract a term used by the employee; perform weighting on the extracted term based on a destination of the email or a number of recipients of the email; perform comparing the extracted term of the employee with an extracted term of another employee in an entire company or within a department; and generate an introductory text for the employee based on a result of the comparing.

The system, wherein the circuitry is configured to: extract a part of speech including a noun, a verb, and an adjective from the term used by the employee using natural language processing technology; calculate an appearance frequency of each term; and weight each term in terms of at least one of the part of speech, the appearance frequency, a number of recipients of the email, a job title of a recipient of the email, and presence or absence of CC (Carbon Copy) or BCC (Blind Carbon Copy) of the email.

The system, wherein the circuitry is configured to: measure how characteristic a specific term is for the employee using TF-IDF (Term Frequency-Inverse Document Frequency); perform weighting on a term that is frequently used but rarely seen by other employees; and generate, using AI, the introductory text incorporating a skill of the employee determined by measuring how characteristic the specific term is for the employee, and a weight in the weighting.

A method for evaluating capabilities of an employee, comprising: receiving an email or a document of the employee as input data; analyzing the input data to extract a term used by the employee; performing weighting on the extracted term based on a destination of the email or a number of recipients of the email; performing comparing the extracted term of the employee with an extracted term of another employee in an entire company or within a department; and generating an introductory text for the employee based on a result of the comparing.

1. A system for evaluating capabilities of an employee, comprising circuitry configured to:
receive an email or a document of the employee as input data;
analyze the input data to extract a term used by the employee;
perform weighting on the extracted term based on a destination of the email or a number of recipients of the email;
perform comparing the extracted term of the employee with an extracted term of another employee in an entire company or within a department; and
generate an introductory text for the employee based on a result of the comparing.

2. The system according to claim 1,
wherein the circuitry is configured to:
extract a part of speech including a noun, a verb, and an adjective from the term used by the employee using natural language processing technology;
calculate an appearance frequency of each term; and
weight each term in terms of at least one of the part of speech, the appearance frequency, a number of recipients of the email, a job title of a recipient of the email, and presence or absence of CC (Carbon Copy) or BCC (Blind Carbon Copy) of the email.

3. The system according to claim 1,
wherein the circuitry is configured to:
measure how characteristic a specific term is for the employee using TF-IDF (Term Frequency-Inverse Document Frequency);
perform weighting on a term that is frequently used but rarely seen by other employees; and
generate, using AI, the introductory text incorporating a skill of the employee determined by measuring how characteristic the specific term is for the employee, and a weight in the weighting.

4. A method for evaluating capabilities of an employee, comprising:
receiving an email or a document of the employee as input data;
analyzing the input data to extract a term used by the employee;
performing weighting on the extracted term based on a destination of the email or a number of recipients of the email;
performing comparing the extracted term of the employee with an extracted term of another employee in an entire company or within a department; and
generating an introductory text for the employee based on a result of the comparing.
